(19) United States
(12) Patent Application Publication
(10) Pub. No.: US 2022/0284804 A1
(43) Pub. Date: Sep. 8, 2022

(54) AUTOMATIC PARAMETERIZATION OF A SENSOR BY MEANS OF A VIRTUAL TWIN

(71) Applicant: VEGA GRIESHABER KG, Wolfach (DE)

(72) Inventor: Clemens HENGSTLER, Haslach (DE)

(73) Assignee: VEGA GRIESHABER KG, Wolfach (DE)

(21) Appl. No.: 17/689,289

(22) Filed: Mar. 8, 2022

(30) Foreign Application Priority Data
Mar. 8, 2021 (DE) 10 2021 202 210.3

(51) Int. Cl. G08C 21/00; G06K 11/00; H04Q 9/04

(52) U.S. Cl. CPC G08C 21/00; G06K 11/00; H04Q 9/04

(57) ABSTRACT

A control device for parameterizing a sensor of a measuring system that determines, at least via a virtual twin of the measuring system, a target position of the sensor in a site. Furthermore, the control device transmits the determined target position to the measuring system and/or to a user. The control device furthermore parameterizes the sensor in the measuring site.

### CROSS-REFERENCE TO RELATED APPLICATIONS

This application claims the benefit of the filing date of German Patent Application No. 10 2021 202 210.3 filed on 8 Mar. 2021, the entire content of which is incorporated herein by reference.

### FIELD

The disclosure relates to the parameterization of sensors in measuring systems and/or in measuring sites. In particular, the disclosure relates to a control device for parameterizing a sensor of a measuring system, a measuring system with such a control device, a sensor, a program element, a computer-readable medium, and the use of such a control device.

### BACKGROUND

Inaccurate or wrong parameterization, calibration and commissioning of a sensor can have great consequences on the measurements of the sensor and especially on its quality and reliability. In addition, it may be necessary to parameterize the sensor at its point of use, so that it can be associated with great effort. For example, successful parameterization may include accurate and correct positioning of the sensor. Parameterizing a sensor can thus prove to be complex. Depending on the intended use, it may also be necessary to calibrate the sensor so that the physical measured value determined is converted into a useful measured value, i.e., information.

In addition, the parameterization of a sensor can become considerably more complex if the sensor is part of a measuring system. It may happen that several sensors of the same type are to be parameterized at different positions in the plant. Many measuring systems also have a large number of different sensors.

### SUMMARY

There may be a desire to provide a control device which performs the parameterization of a sensor of a measuring system and/or the commissioning of a sensor efficiently, reliably, automatically and accurately.

This desire is met by the features of the independent patent claims. Further embodiments of the present disclosure result from the subclaims and the following description of embodiments.

A first aspect of the present disclosure relates to a control device for parameterizing a sensor of a measuring system. The control device is configured to:
determine, at least via a virtual twin of the measuring system, a target position of the sensor, in particular a target position of the sensor in a plant or site, in particular in a measuring site;
transmit the determined target position to the measuring system and/or to a user; and
parameterize the sensor, in particular to parameterize the sensor in the plant or site.

The control device may generally be one or more control units, control units, or the like. Such a control device may be located in one or more computers, in one or more operator devices, in one or more clouds, or in various electronic devices of any kind. The control device may, for example, receive, transmit, analyze, and/or evaluate data. The data may be, for example, a position, such as a target position, position parameters, measuring system-specific information, and/or sensor-specific information.

The control device can be configured to determine a target position of the sensor. In this regard, the target position may be determined, calculated and/or evaluated by means of a virtual twin of the measuring system and/or the equipment, which may comprise the sensor.

It should also be noted that the term “target position” should be understood broadly in the context of the present disclosure. The target position may generally refer to a position associated with the sensor, whether or not the sensor is already at the target position. The target position may likewise be understood as a target position. This can be understood to mean that the sensor may be located at the target position so that it can fulfill its purpose, such as performing a measurement, as reliably and accurately as possible.

The term “virtual twin” is likewise to be understood broadly in the context of the present disclosure. It may refer to a plan, a 2D or 3D plan, a schedule, a model, and/or a data model of the entire measuring system. It may also refer to the virtual twin by the term “digital twin”. The virtual twin may likewise refer to one or more databases. It can also be just an image or digital map and tank dimensions are calculated from it using image processing. Alternatively or additionally, for example, the image processing and the current position can also be used to determine that the sensor must be installed on a tank. Since there can be several image-identical tanks on the image in the plant, the sensor can request the parameterization of the surrounding sensors and adopt this for itself.

When replacing a sensor, e.g. in a measuring system, it may be necessary to re-parameterize and/or calibrate the sensor. It should be noted that the term measuring system is to be understood broadly. It can refer to any type of plant. Parameterization of the sensor can also be advantageous, for example, during maintenance. Parameterization of the sensor can also be necessary during commissioning of a sensor. To parameterize a new or an old sensor, the control device can determine the target position of the sensor. This may involve determining and/or identifying the exact or relevant sensor which, according to the virtual twin, should be or will be parameterized. Based on the target position, the control device can infer the relevant sensor by means of the virtual twin. It may be conceivable that a measuring system comprises a plurality of sensors, so that it may prove advantageous to be able to automatically determine the determination of the target position of the sensor concerned. The control device may be configured to automatically parameterize the sensor.

Once the target position of the sensor has been determined, it can be communicated to the measuring system, to a higher-level system, to a cloud, to the sensor itself, and/or to the user. For example, if the sensor is already located at the target position, the target position can be communicated to the user so that the user can perform the appropriate maintenance or parameterization to the correct sensor in question. In addition, the parameterization of the sensor may have the commissioning of the same sensor. In this case, the target position of the sensor may first be communicated to the user, for example, via an operator interface. The user can thus place the sensor at its target position. Likewise, it is conceivable that the target position, which may have been determined by the control device, may be transmitted to the sensor itself. The sensor in question could, for example, be retrieved as a result, and warned that it should be parameterized or the like.

Finally, the control device can parameterize and calibrate the sensor and/or instruct and/or perform commissioning. The control device can call up the data required for parameterization and/or commissioning from the virtual twin, for example, and transmit it to the sensor. It is also conceivable that the sensor, as soon as it has been arranged at the target position, itself retrieves the necessary data for parameterization and/or commissioning from the virtual twin. The sensor and/or the control device can also retrieve the data for parameterization from other databases, such as a cloud. In the case of an old sensor that is to be re-parameterized, the data that is already on the sensor can be compared with the data of the virtual twin. If there is a discrepancy, for example, the data on the sensor can be replaced with the data from the virtual twin, or the user can be asked which data should be retained. It should be noted that the virtual twin may be fully or partially stored in a cloud, so that data exchange with the cloud can take place.

In other words, the position of the sensor can be used to pull the appropriate data from the digital twin using the control device.

Such parameterization of the sensor by means of the control device can prove advantageous, since the need for a specialist can be eliminated in the event of, for example, a sensor replacement. Based on the data from the virtual twin and on the determination of the target position of the sensor, the control device can, for example, recognize exactly which sensor is involved, for example even down to the sensor identifier or serial number, and how this sensor is to be parameterized. Parameterization and/or commissioning of the sensor can thus be performed easily, with little effort, efficiently, reliably and accurately.

According to an embodiment, the control device is further configured to determine the current position of the sensor in order to perform a comparison with the target position. The control device can determine the current position of the sensor by, for example, retrieving the position of the sensor from the sensor itself. In other words, the control device is used to determine where exactly the sensor is located. For example, it is determined at which container, at which process connection and/or in which direction the sensor is located. Thus, an alignment can be performed between the determined position of the sensor and the target position. The adjustment can be a comparison and/or an adjustment of the current position.

Determining at which process connection the sensor is located can be done, for example, by comparing the sensor characteristics, such as process connections which are queried from a database in the sensor or at the sensor manufacturer, and the tank characteristics which are queried from the digital twin or a database at the associated tank manufacturer. If the sensor with the process connection only fits onto this tank at one point, because the corresponding counterpart is there, the exact position can be determined from this, for example. It can also be used to determine all the data for the adjustment from the digital twin.

According to an embodiment, the determination of the current position of the sensor is based at least partially on a determination of signal strengths of further sensors. In addition, the determination of the current position of the sensor is at least partially based on the current positions of further sensors which are known from the virtual twin. In other words, it is conceivable that the sensor can determine the signal strengths of the surrounding sensors using, for example, a radio module. Since the positions of the other sensors can be precisely assigned to the virtual twin, the sensor can thus determine its position, such as its current position, on the basis of the radio strengths and/or signal strengths of its surrounding sensors, in particular determine it reliably. Such a determination of the current position of the sensor can be used, for example, as redundancy for the determination of the current position of the sensor. In a first determination, for example, the current position of the sensor can be determined based on a position detection system and verified based on the radio strengths of the surrounding sensors.

According to an embodiment, the current position and/or the target position has a location, an orientation, one or more position parameters, and/or an adjustment angle. The current position and/or the target position of the sensor may generally be a position that may enable circumferential identification of the sensor. In this regard, the respective position may have different position parameters, such as a port, a container associated with the sensor, a height, etc.

According to an embodiment, the control device is further configured to transmit, by the sensor and/or by the user, the current position of the sensor to the measuring system. Alternatively or additionally, the current position of the sensor can be transmitted to a cloud, a higher-level system, a control device and/or to a user. The control device is also configured to match the current position of the sensor with the target position of the sensor. The control device can be arranged in a computer, in a cloud, in an operating device and/or in the sensor itself.

According to an embodiment, the control device is also configured to transmit sensor-specific information to the measuring system.

Alternatively or additionally, the control device is also configured to match the determined sensor-specific information with sensor-specific information of the virtual twin. The sensor-specific information can be, for example, the sensor type, the measuring principle or the process connection. It is conceivable, for example, that two sensors with a difference of only a few centimeters can or must be arranged next to each other on a container, but which have to measure different sizes.

In other words, the current position of the sensor can be determined by matching the sensor-specific information with sensor-specific information of the virtual twin. In doing so, the sensor-specific information of the sensor can be compared with the data of the virtual twin in order to find an exact assignment of the sensor in the measuring system.

According to an embodiment, the control device is further configured to query, via a user interface, position information that at least partially defines the target position and/or the current position. Alternatively or additionally, the control device is arranged to verify the current position of the sensor. In other words, the control device can be used to verify whether the sensor is located at the correct position, such as the target position. The verification of the current position of the sensor may be fully automatic. The verification of the current position of the sensor can be performed by the control device as well as by the measuring system. Alternatively or additionally, the user himself can verify the current position of the sensor and, for example, validate or reject it via an interface.

According to an embodiment, the control device is configured to further perform the following steps during the matching process:
Determining a deviation between the current position of the sensor and the determined target position of the sensor; and/or
Querying, via an interface of the sensor and/or the measuring system, based on the determination of the deviation, position information that at least partially defines the target position and/or the current position;
Parameterizing and/or attaching the sensor to the target position based on the queries

It is conceivable that the sensor is not at its target position. If a deviation between the current position of the sensor and the target position of the sensor is detected or determined via the control device, further information that could explain the deviation, for example, can be requested from the user. For example, from the determined current position of the sensor, the control device cannot deduce whether the sensor in question is located inside or outside the container. However, it may be known from the virtual twin of the control device that the sensor should be located inside the sensor, for example. Therefore, position information, such as the current location of the sensor, may be requested from the user. In this regard, the sensor may have an interface, such as a touch screen or a wireless interface.

It is equally conceivable that the particular deviation may be irrelevant to the performance of the measurement concerned. When requesting position information, for example, the user can enter a max deviation that defines an upper limit for a certain deviation that should not be exceeded.

According to an embodiment, the virtual twin is a virtual twin of a plant, such as a measuring plant, with several sensors. It is thus conceivable that the virtual twin contains all the information relating to the system or measuring system that is required, for example, for rebuilding the same measuring system and/or for parameterizing the entire measuring system.

According to an embodiment, the control device is further configured to perform the following steps when parameterizing the sensor:
Retrieving, via the measuring system and/or via the virtual twin, sensor-specific data for parameterizing, calibrating and/or controlling the attached sensor; and/or
Matching, via the measuring system and/or via the virtual twin, of sensor-specific data for parameterization, calibration and/or control of the sensor.

The sensor specific data can be, for example, a TAG name, a bus address, a linearization or a scaling. The sensor specific data can basically contain any kind of data that defines the sensor or the sensor type.

Another aspect of the present disclosure relates to a measuring system. The measuring system comprises a virtual twin, a sensor, and a control device as described above and below. The control device is adapted to control communication, transmission, and/or retrieval of data between, from, or via the sensor and/or the virtual twin.

According to an embodiment, the control device and/or the sensor has an interface. This can be a radio interface, for example.

According to an embodiment, the measuring system further comprises an operating device which is configured to communicate and/or interact with the virtual twin, with the sensor and/or with the control device.

Another aspect of the present disclosure relates to a sensor which is adapted to be parameterized by means of a control device as described above and below.

Another aspect of the present disclosure relates to a program element that, when executed on a control device of a measuring system, instructs the control unit to perform the following steps:
Determining, at least via a virtual twin of the measuring system, a target position of the sensor, in particular a target position of the sensor in a plant, in particular in a measuring plant;
Transmitting the determined target position to the sensor and/or to a user;
Parameterizing the sensor, in particular parameterizing the sensor in the system, in particular in a measuring system.

Another aspect of the present disclosure relates to a computer readable medium having stored thereon a program element as described above.

Another aspect of the present disclosure relates to the use of a control device, as described above and below, for parameterizing a sensor.

In the following, embodiments of the present disclosure are described with reference to the figures. If the same reference signs are used in the following description of figures, these designate the same or similar elements. The illustrations in the figures are schematic and not to scale.

### BRIEF DESCRIPTION OF THE FIGURES

FIG. 1 shows a measuring system with a control device according to a first embodiment.

FIG. 2 shows a measuring system with a control device according to a further embodiment.

FIG. 3 shows a measuring system with a control device according to a further embodiment.

FIG. 4 shows a flow diagram of the use of a control device according to an embodiment.

### DETAILED DESCRIPTION OF EMBODIMENTS

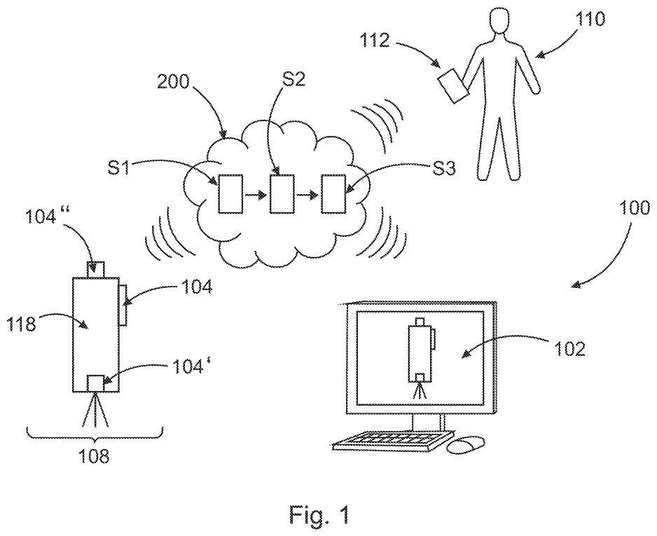

FIG. 1 shows a measuring system 100 according to an embodiment of the present disclosure. The measuring system 100 of FIG. 1 has three sensors 104, 104′, 104″, which may be based on different or the same measurement principles. The sensors 104, 104′, 104″ are attached or mounted to a container 118. The sensors 104, 104′, 104″ together with the container 118 may constitute a measuring site 108. In addition, the measuring system 100 of FIG. 1 includes a virtual twin 102 of the measuring system 100. In particular, the virtual twin 102 may be a virtual twin 102 of the site 108 or measuring site 108. It should be noted that the virtual twin 102 may be stored locally in a computer, for example, or may be retrievable via the Internet of Things. Alternatively or additionally, the virtual twin of the measuring system 100 may be printable on paper.

The measuring system 100 also includes a control device 200. The control device 200 may be stored, for example, in a cloud or in a higher-level system. The control device 200 is arranged to determine S1 of a target position of the sensor 104, in particular a target position of the sensor 104 in the measuring site 108, at least via the virtual twin 102 of the measuring system 100. Thereupon S2 the determined target position of the sensor 104 is transmitted to the measuring system 100, such as to the sensor 104, and/or to a user 110, for example by means of an operating device 112 of the user. Further, the control device 200 is arranged S3 to parameterize the sensor 104 of the measuring site 108.

From the virtual twin 102, such as a 3D drawing, the control device 200 can determine what information, in particular sensor-specific information, may be necessary for parameterization or commissioning.

For example, when parameterizing the sensor 104, a zero point correction can be evaluated as necessary information. Also, the density can be used for the adjustment. The TAG name of the sensor 104 may be automatically drawn from the virtual twin 102. This information may be processed and/or analyzed by the control device 200 to parameterize the sensor 104 accordingly based thereon. The sensor 104 may be put into operation in the field, i.e., powered, and subsequently function properly.

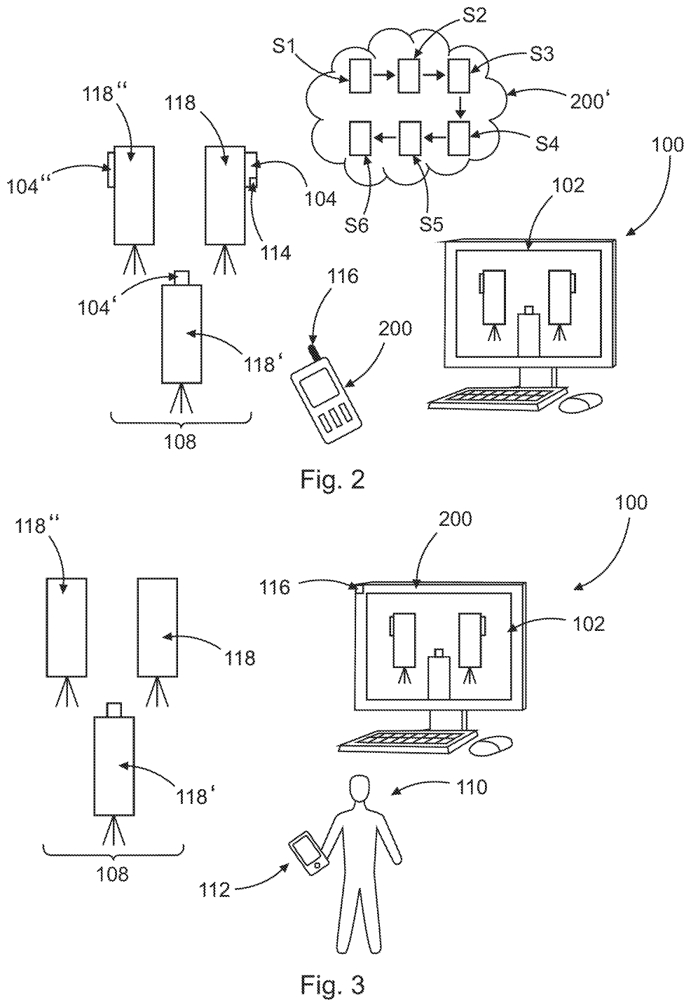

FIG. 2 shows a measuring system 100 according to a further embodiment of the present disclosure. Unless otherwise described, the measuring system 100 of FIG. 2 has the same elements and/or components as the measuring system of FIG. 1. The measuring system 100 of FIG. 2 comprises a plurality of sensors 104, 104′, 104″ arranged or connected to different containers 118, 118′, 118″. The control device 200, 200′ of the measuring system 100 of FIG. 2 is arranged in part in a control unit. The sensor 104 may further include an interface 114. The interface 114 may be used, for example, to allow the user 110 to enter or adjust settings, information, and/or parameters. The interface 114 may likewise serve to communicate with the operator interface.

The control device 200 of FIG. 2 is further configured S4 to determine the current position of the sensor 104 to perform a match with the target position. In other words, the control device 200 can retrieve, determine, or calculate the exact current location of the sensor 104 and/or the container 118 on which it is located and/or the physical quantity it could or can currently measure. A target position of the sensor 104 is known from the virtual twin 102. Ideally, the current position of the sensor 104 should correspond to the target position of the sensor 104. By knowing both positions to the control device 200, an alignment between the two positions can be guided or performed based thereon.

However, it may not be possible to accurately determine the current position of the sensor 104. In other words, the control device 200 may not be able to infer a single target position known from the virtual twin. For example, the sensor 104 may communicate its geographic position to the control device 200. Based on this, two or more possible current positions may be inferred by means of the control device via the virtual twin. However, information may also be missing to infer a single one of the two or more possible positions. In this regard, the user 110 may be presented with a selection of the corresponding possible current positions of the sensor 104 in the control device 200, such as via a user interface 112, or at the sensor. Thereupon, the user 110 may select the correct position, that is, the one corresponding to the target position.

Alternatively or additionally, the sensor 104 may determine the signal strengths of the surrounding sensors 104′, 104″, such as the other sensors attached to the same container 118, using a radio module or the like. The current positions of the further sensors 104′, 104″ may already be accurately associated with the virtual twin so that the current position of the sensor 104 can be determined or better determined based on the radio strengths and/or signal strengths of the surrounding sensors 104′, 104″.

In addition, the control device S5 may serve to transmit, by the sensor 104 and/or by the user 110, the current position of the sensor 104 to the measuring system 100. After the current position of the sensor 104 has been transmitted, an S6 matching of the current position of the sensor 104 with the target position of the sensor 104 can now be performed.

Further, the control device 200 may determine what information may be necessary for matching the target position and the current position of the sensor 104. For example, it may be necessary for the type of process connection of the sensor 104 to the target position and the current position to be known, so that the matching may be based not only on the geographic position of the sensor 104, but may also be based on the physical and mechanical setting of the sensor. If a discrepancy is detected during the alignment of the target position and the current position, the discrepancy may be within a predefined tolerance range, for example, so that the alignment may still result from a basic match between the two positions.

During adjustment, sensor-specific information, such as TAG name, bus address, min-max adjustment, linearization, and/or scaling, may be written to the sensor 102 from a higher-level system, i.e., from a cloud, from the measuring system 100, and/or from the control device 200.

The control device 200, which is stored in a cloud, for example, or the sensor 104 can also derive further information or data from the virtual twin 102. In the case of a level measurement with radar, for example, a high frequency and a particularly precise focusing may be required, as this means that there are few interfering reflections from fixtures or the tank wall. However, difficulties can arise at the bottom of the tank because the signal only reaches the sensor via detours. Thanks to the virtual twin 102 having information about the position, location and/or orientation of the sensor 104, i.e. position information or position parameters, it may be conceivable that interfering reflections that may occur can already be simulated and/or calculated in the control device 200. For example, the control device itself can determine the end of a measuring range depending on the tank geometry or container geometry. The measurement reliability and commissioning of the sensor 104 can thus be kept high and simple.

Furthermore, based on the knowledge of the exact tank geometry, for example, an echo curve in a radar level measurement can be accurately interpreted, especially in the case of multiple echoes. The control device shown in FIG. 2 can be used to precisely parameterize the sensor 104, in particular a level measurement sensor. Additionally, however, information about the container 118 and the installation can be copied from the virtual twin 102 and written to the sensor 102. This allows the sensor 104 itself to best interpret the echo curve.

FIG. 3 shows a measuring system 100 according to a further embodiment of the present disclosure. Unless otherwise described, the measuring system 100 of FIG. 3 has the same elements and/or components as the measuring system of FIGS. 1 and 2. The measuring system 100 of FIG. 3 comprises a measuring site 108, which still has to be equipped with sensors 104, 104′, 104″. The measuring site 108 has three containers 118, 118′, 118″. Using the virtual twin 102, which can be shown in a computer, for example, each sensor 104, 104′, 104″ can be told which is its associated target position. In other words, the control device 200 can communicate to the sensor, by means of the virtual twin 102, where it belongs and what size it is to measure, for example. The user 110 may then, for example, place the sensors in the corresponding target positions. The user 110 may be instructed, for example, via a control device 112, where and how to mount the sensor 104. Alternatively or additionally, the sensor 104 itself may provide the user 110 with the necessary information to mount the sensor 104 to the container 118. The sensor 104 may have received this information in advance from the control device 200. The information may be an orientation, a location, a particular container, an embodiment, a connection, a bus address, and/or a setting angle. For example, the control device 200 knows the embodiments of the sensor or has access to them via the virtual twin 102 of the measuring site 108.

Once the sensor 104 is attached to the container 118 based on the virtual twin 102 of the measuring site 108, commissioning of the sensor 104 may be automatic. Once the sensor 104 is powered, it can determine its position, such as via a navigation satellite system, its orientation and location, and communicate this to the measuring system 100, a cloud, a higher-level system, the control device 200, and/or the user. For example, the measuring system 100 has access to the virtual twin 102 of the measuring system 100, in particular the measuring site 108, via an interface. The position and orientation of the sensor can be used to assign it to the respective tank or container 118. Additionally or alternatively, the system may know which embodiments the sensor 104 has, such as sensor type, measurement principle or process connection. Thus, the system 100 or the control device 200 can independently, automatically and reliably determine on which of the possible nozzles or process connections the sensor 104 must or should be installed or mounted.

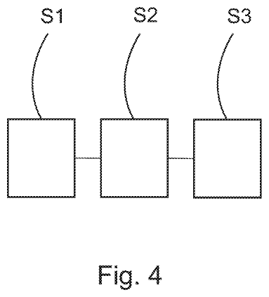

FIG. 4 shows a flowchart of the use of a control device 200 according to one embodiment. In other words, the flowchart of FIG. 4 shows the steps that can be performed by a control device 200. For example, these steps may be performed by a control device 200 of FIG. 1, 2, or 3, or when using a control device 200 of FIG. 1, 2, or 3.

In a first step S1, a target position of the sensor, in particular a target position of the sensor in a measuring site 108 is determined via a virtual twin 102 of the measuring system 100. Thereby, it can be determined where exactly in the measuring site 108 and/or at a container 118 the sensor 104 must or should be arranged. Thereupon, in a next step S2, the target position is transmitted to the measuring system 100 and/or to a user 110 by the control device 200. Alternatively or additionally, the target position may be transmitted from a higher-level system, a cloud, and/or from the virtual twin 102. In a third step S3, the sensor 104 is parameterized. Here, part of parameterizing the sensor 104 may include retrieving data from a database, such as a database of the control device 200 and/or the virtual twin 102. In particular, the sensor 104 may be parameterized, calibrated and/or commissioned in the measuring site 108.

Supplementally, it should be noted that “comprising” and “having” do not exclude other elements or steps, and the indefinite articles “a” or “an” do not exclude a plurality. It should further be noted that features or steps that have been described with reference to any of the above embodiments may also be used in combination with other features or steps of other embodiments described above. Reference signs in the claims are not to be regarded as limitations.

1. A control device configured to parameterize a sensor of a measuring system, comprising:
processing circuitry configured to:
determine, at least via a virtual twin of the measuring system, a target position of the sensor in a measuring site,
transmit the determined target position to the measuring system and/or to a user, and
parameterize the sensor in the site.

2. The control device of claim 1, wherein the processing circuitry is further configured to:
determine a current position of the sensor to perform an alignment with the target position.

3. The control device according to claim 2,
wherein the processing circuitry is further configured to determine the current position of the sensor based at least in part on being configured to determine signal strengths from further sensors; and
wherein the processing circuitry is further configured to the current position of the sensor based at least in part on current positions of the further sensors known from the virtual twin.

4. The control device according to claim 2,
wherein the current position and/or the target position includes a position, an orientation, one or more position parameters, and/or a setting angle.

5. The control device according to claim 1, wherein the processing circuitry is further configured to:
transmit, by the sensor and/or by the user, the current position of the sensor to the measuring system, and
match the current position of the sensor with the target position of the sensor.

6. The control device according to claim 1, wherein the processing circuitry is further configured to:
transmit, by the sensor, sensor-specific information to the measuring system; and/or
match the sensor-specific information with sensor-specific information of the virtual twin.

7. The control device according to claim 1, wherein the processing circuitry is further configured to:
request, via a user interface, position information that at least partially defines the target position and/or the current position, and/or
verify the current position of the sensor.

8. The control device according to claim 6, wherein the processing circuitry is further configured to, when matching:
determine a deviation between the current position of the sensor and the determined target position of the sensor,
query, via an interface of the sensor and/or the measuring system, based on the determination of the deviation, position information that at least partially defines the target position and/or the current position, and/or
parameterize and/or attach the sensor to the target position based on interrogation.

9. The control device according to claim 1,
wherein the virtual twin is a virtual twin of a site having a plurality of sensors.

10. The control device according to claim 1, wherein the processing circuitry is further configured to, when parameterizing the sensor:
retrieve, via the measuring system and/or via the virtual twin, sensor-specific data for parameterizing, calibrating and/or controlling the sensor, and/or
match, via the measuring system and/or via the virtual twin, sensor-specific data for parameterizing, calibrating and/or controlling the sensor.

11. A measuring system, comprising:
a virtual twin;
a sensor; and
a control device configured to parameterize a sensor of a measuring system, including processing circuitry configured to determine, at least via a virtual twin of the measuring system, a target position of the sensor in a measuring site, transmit the determined target position to the measuring system and/or to a user, and parameterize the sensor in the site,
wherein the control device is configured to control communication, transmission and/or retrieval of data between, from or via the sensor and/or the virtual twin.

12. The measuring system according to claim 11,
wherein the control device and/or the sensor includes an interface.

13. The measuring system according to claim 11, further comprising:
a user interface configured to communicate and/or interact with the virtual twin, with the sensor, and/or with the control device.

14. A sensor which is configured to be parameterized by the control device according to claim 1.

15. A non-transitory computer readable medium having stored thereon a program element which, when executed by a control device of a measuring system, causes the control device to implement a control method, comprising:
determining, at least via a virtual twin of the measuring system, a target position of a sensor in a site;
transmitting the determined target position to the sensor and/or to a user; and
parameterizing the sensor in the site.

16. The control device according to claim 3,
wherein the current position and/or the target position includes a position, an orientation, one or more position parameters, and/or a setting angle.

17. The control device according to claim 2, wherein the processing circuitry is further configured to:
transmit, by the sensor and/or by the user, the current position of the sensor to the measuring system, and
match the current position of the sensor with the target position of the sensor.

18. The control device according to claim 2, wherein the processing circuitry is further configured to:
transmit, by the sensor, sensor-specific information to the measuring system; and/or
match the sensor-specific information with sensor-specific information of the virtual twin.

19. The control device according to claim 2, wherein the processing circuitry is further configured to:
request, via a user interface, position information that at least partially defines the target position and/or the current position, and/or
verify the current position of the sensor.

20. The measuring system according to claim 12, further comprising:
a user interface configured to communicate and/or interact with the virtual twin, with the sensor, and/or with the control device.
